(19) United States
(12) Patent Application Publication
(10) Pub. No.: US 2012/0262299 A1
(43) Pub. Date: Oct. 18, 2012

(54) EARTHQUAKE-TRIGGERED EMERGENCY INDICATOR

(76) Inventor: Chia-Chun HUNG, Hsin-Chu (TW)

(21) Appl. No.: 13/086,901

(22) Filed: Apr. 14, 2011

(51) Int. Cl. G08B 17/10; G08B 21/00

(52) U.S. Cl. 340/628; 340/690

(57) ABSTRACT

An earthquake-triggered emergency indicator includes an earthquake detector, an indicator, a controller, and a battery module. The earthquake detector is configured for detecting a vibration. The indicator is configured for generating an indication signal in a form of light, sound or vibration to guide a user to take an emergency measure. The controller is configured for generating a trigger signal based on a magnitude and a lasting time of the vibration so as to trigger the indicator to output the correspondent indication signal. The battery module is configured for providing power supply required for operation of the earthquake-triggered emergency indicator. Preferably, the above-mentioned earthquake-triggered emergency indicator includes a wireless communication module for connecting multiple earthquake-triggered emergency indicators to reduce adverse effects caused by malfunctioning single emergency indicator.

### BACKGROUND OF THE INVENTION

1. Field of the Invention

The present invention relates to an emergency indicator, particularly to an earthquake-triggered emergency indicator.

2. Description of the Prior Art

In recent years, there have been earthquakes at many places in the world resulted in major disasters having many casualties. The function of conventional emergency exit indicators is only limited to passive indication for exit instead of spontaneously detecting the occurrence of earthquakes and alerting users for appropriate emergency measures. In addition, since conventional emergency exit indicators are mainly installed at the end of a hall and an exit for exit indication, the making of appropriate escaping judgments for public citizen may be severely influenced in the occurrence of disasters if any one of the emergency indicators is broken.

To sum up, it is now a current goal to develop an emergency indicator that is capable of being triggered by an earthquake and configured for alerting users for appropriate emergency measures.

### SUMMARY OF THE INVENTION

The present invention is directed to an earthquake-triggered emergency indicator, which includes an earthquake detector spontaneously detecting the occurrence of an earthquake and alerts users for appropriate emergency measures in the occurrence of an earthquake. Preferably, the present invention includes a wireless communication module so that any one of earthquake-triggered emergency indicators of the present invention that detects the occurrence of an earthquake may trigger other earthquake-triggered emergency indicators within range of communication. Therefore, failure for indicating emergency direction in the case of existing of some malfunctioning earthquake-triggered emergency indicators may thus be prevented.

In one embodiment, an earthquake-triggered emergency indicator of the present invention includes an earthquake detector, an indicator, a controller, and a battery module. The earthquake detector is configured for detecting a vibration. The indicator is configured for generating an indication signal in a form of light, sound or vibration to guide a user to take an emergency measure. The controller is electrically connected to the earthquake detector and the indicator, and configured for generating a trigger signal based on a magnitude and a lasting time of the vibration so as to trigger the indicator to output the correspondent indication signal. The battery module is configured for providing power supply required for operation of the earthquake-triggered emergency indicator.

Other advantages of the present invention will become apparent from the following descriptions taken in conjunction with the accompanying drawings wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed descriptions, when taken in conjunction with the accompanying drawings, wherein:

FIG. 1 is a schematic diagram illustrating an earthquake-triggered emergency indicator according to one embodiment of the present invention.

### DESCRIPTION OF THE PREFERRED EMBODIMENT

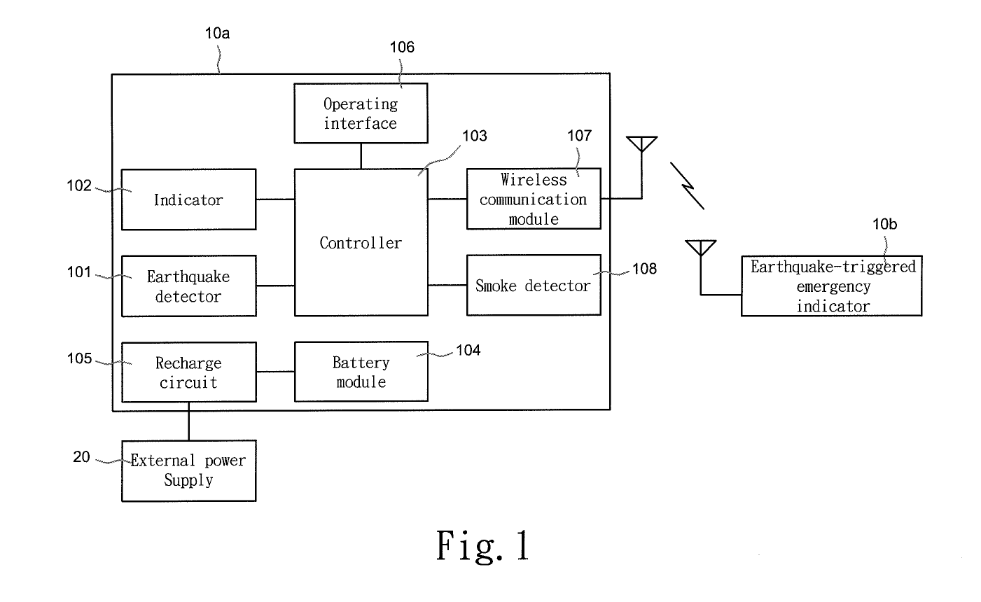

Referring to FIG. 1, an earthquake-triggered emergency indicator 10a according to one embodiment of the present invention includes an earthquake detector 101, an indicator 102, a controller 103 and a battery module 104. The earthquake detector 101 is configured for detecting vibration caused by earthquakes. The earthquake detector 101, for example, may be an accelerometer. The indicator 102 may be configured for generating an indication signal, such as light, sound or vibration, to guide a user to take relevant emergency measures. For example, the indicator 102 may be an LED, a speaker, a vibrating motor or combinations thereof. The controller 103 is electrically connected to the earthquake detector 101 and the indicator 102. The occurrence of earthquakes is then determined by the controller 103 based on the magnitude and lasting time of vibration detected by the earthquake detector 101. In the case of earthquake occurrence, a trigger signal is generated by the controller 103 so as to trigger the indicator 102 to output a correspondent indication signal. For example, when vibration magnitude of an earthquake detected by the earthquake detector 101 is determined to be greater than scale 4.0, the vibration lasting time would be recorded by the controller 103. In the case of vibration lasting time longer than 5 sec or 10 sec, a trigger signal is generated by the controller 103 to trigger the indicator 102 to emit light, vocal voice or alert sound or vibrate prompting for appropriate measures.

The battery module 104 is configured for providing power supply required for operation of the earthquake-triggered emergency indicator 10a. The battery module 104, for example, may be disposable batteries or rechargeable batteries. In one embodiment, the earthquake-triggered emergency indicator 10a of the present invention includes a recharge circuit 105 electrically connected to the battery module 104. When the recharge circuit 105 is electrically connected to an external power supply 20, the battery module 104 may be recharged by the recharge circuit 105.

In one embodiment, the earthquake-triggered emergency indicator 10a of the present invention includes an operating interface 106 electrically connected to the controller 103. The operating interface 106 may be input via buttons, for example. The operating interface 106 may be configured for users to setup or modify trigger conditions such as magnitude and lasting time of vibration. For example, the trigger criteria for recording lasting time of vibration may be set to be vibration greater than scale 4.0, 5.0 or 6.0 earthquakes detected by the earthquake detector 101.

Still referring to FIG. 1, in one embodiment, the earthquake-triggered emergency indicator 10a of the present invention further includes a wireless communication module 107 electrically connected to the controller 103. Therefore, information exchange between the earthquake-triggered emergency indicators 10a and 10b may be achieved by the wireless communication module 107. For example, the wireless communication module 107 may be compliant to IEEE 802.15.4 protocol, in terms of ZigBee wireless network protocol, with characteristics of low power consumption, low cost, mass network nodes compatible, multiple network topology compatible, low complexity, high speed, reliance and security. The trigger signal generated by the controller 103 may be transmitted via the wireless communication module 107 of the earthquake-triggered emergency indicator 10a. The trigger signal transmitted by the earthquake-triggered emergency indicator 10a is then received by the other earthquake-triggered emergency indicator 10b and triggers the indicator of the earthquake-triggered emergency indicator 10b.

Based on the provided configuration, in the case of one earthquake detector 101 of either one of the earthquake-triggered emergency indicator 10a and 10b being malfunctioning, the indicator of the malfunctioning earthquake-triggered emergency indicator may be triggered by the other earthquake-triggered emergency indicators. In addition, combinations of multiple earthquake-triggered emergency indicators 10a and 10b may achieve various applications. For example, the indicator may be configured for generating blinking light so as to prompt users for appropriate measures. There may be time lapse existing between blinking periods of the indication signal of multiple earthquake-triggered emergency indicators, and the emergency direction is indicated, therefore. For example, the indicators of earthquake-triggered emergency indicators adjacent to or closer to the exit are brighter in contrast to the dimmed indicators of one earthquake-triggered emergency indicators; or the light signals are sequentially turned on within visual range so as to indicate the exit direction for users. In one embodiment, the brightness difference between light signals may also be used for indicating the exit direction. For example, the earthquake-triggered emergency indicator closer to the exit gives off brighter indicator signals for users to judge direction to the exit based on the brightness difference between light signals of adjacent earthquake-triggered emergency indicators.

Still referring to FIG. 1, the earthquake-triggered emergency indicator 10a of the present invention further includes a smoke detector 108 electrically connected to the controller 103 and configured for detecting smoke. In the case of ambient parameters, such as smoke concentration, being larger than a given value, a trigger signal is generated by the controller 103 to trigger the indicator 102 to output correspondent indication signals such as a vocal signal indicating “ALERT! FIRE!”. Therefore, adverse effects in the occurrence of the natural calamities where emergency indicators installed at the end of a hall and an exit are masked by smoke may be lowered by massive installation of earthquake-triggered emergency indicators of the present invention and the above-mentioned ways for indicating exit direction.

To sum up, the earthquake-triggered emergency indicator of the present invention spontaneously detects the occurrence of earthquakes by installing an earthquake detector and alerts users for appropriate emergency measures in the occurrence of earthquakes instead of passive indication for exit. Preferably, multiple earthquake-triggered emergency indicators of the present invention may be connected by wireless communication modules, and once any one of the earthquake-triggered emergency indicators detects the occurrence of an earthquake, the other earthquake-triggered emergency indicators within communication range may be triggered. Therefore, adverse effects such as failing to indicate exit direction may be lowered when there are some emergency indicators.

While the invention can be subject to various modifications and alternative forms, a specific example thereof has been shown in the drawings and is herein described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. An earthquake-triggered emergency indicator, comprising:
an earthquake detector configured for detecting a vibration;
an indicator configured for generating an indication signal in a form of light, sound or vibration to guide a user to take an emergency measure;
a controller electrically connected to the earthquake detector and indicator, and configured for generating a trigger signal based on a magnitude and a lasting time of the vibration so as to trigger the indicator to output the correspondent indication signal; and
a battery module configured for providing power supply required for operation of the earthquake-triggered emergency indicator.

2. The earthquake-triggered emergency indicator as claimed in claim 1, further comprising:
a wireless communication module electrically connected to the controller and configured for transmitting the trigger signal to be received by another earthquake-triggered emergency indicator and to trigger the indicator thereof.

3. The earthquake-triggered emergency indicator as claimed in claim 2, wherein the indicator is configured for generating the indication signal having a blinking light and there is time lapse existing between blinking periods of the indication signal of multiple earthquake-triggered emergency indicators for indicating emergency direction.

4. The earthquake-triggered emergency indicator as claimed in claim 2, wherein the indicators of the earthquake-triggered emergency indicator closer to an exit are brighter for indicating emergency direction.

5. The earthquake-triggered emergency indicator as claimed in claim 2, wherein the wireless communication module is compliant to IEEE 802.15.4 protocol.

6. The earthquake-triggered emergency indicator as claimed in claim 1, further comprising:
a smoke detector electrically connected to the controller and configured for detecting a smoke, wherein the controller generates the trigger signal based on the smoke to trigger the indicator to output the correspondent indication signal.

7. The earthquake-triggered emergency indicator as claimed in claim 1, further comprising:
an operating interface electrically connected to the controller and configured for users to setup at least one of the magnitude and the lasting time of the vibration for the trigger signal.

8. The earthquake-triggered emergency indicator as claimed in claim 1, further comprising:
a recharge circuit electrically connected to the battery module and configured for recharging the battery module when the recharge circuit is electrically connected to an external power supply.

9. The earthquake-triggered emergency indicator as claimed in claim 1, wherein the earthquake detector comprises an accelerometer.

10. The earthquake-triggered emergency indicator as claimed in claim 1, wherein the indicator comprises an LED, a speaker, a vibrating motor or combinations thereof.
